(19) United States
(12) Patent Application Publication
(10) Pub. No.: US 2020/0001310 A1
(43) Pub. Date: Jan. 2, 2020

(54) CYCLONE INTEGRATED TYPE STORAGE DEVICE, INTEGRATED GASIFICATION COMBINED CYCLE, AND METHOD FOR SEPARATING PARTICLES

(71) Applicant: MITSUBISHI HITACHI POWER SYSTEMS, LTD., Yokohama-shi, Kanagawa (JP)

(72) Inventors: Haruto Shinoda, Yokohama-shi (JP); Yuichiro Urakata, Yokohama-shi (JP); Yasunari Shibata, Yokohama-shi (JP); Yoshinori Koyama, Tokyo (JP); Katsuhiko Yokohama, Tokyo (JP)

(73) Assignee: MITSUBISHI HITACHI POWER SYSTEMS, LTD., Yokohama-shi, Kanagawa (JP)

(21) Appl. No.: 16/466,169

(22) PCT Filed: Jan. 19, 2018
(86) PCT No.: PCT/JP2018/001530

§ 371 Date: Jun. 3, 2019

(30) Foreign Application Priority Data
Jan. 19, 2017 (JP) 2017-007668

(51) Int. Cl. B04C 5/185; F02C 6/04; C10J 3/52; B04C 5/12; B04C 9/00; B01D 45/16; B01D 50/00

(52) U.S. Cl. CPC B04C 5/185; F02C 6/04; C10J 3/52; B04C 5/12; B04C 2009/002; B01D 45/16; B01D 50/002; C10J 2300/1628; C10J 2300/1675; B04C 9/00

(57) ABSTRACT

A cyclone integrated type storage device that helps to reduce equipment costs, which includes: a hollow pressure vessel; a cyclone provided in a vertically upper part of the pressure vessel and configured to swirl a produced gas introduced from outside and containing particles to thereby separate at least some of char from the produced gas, the cyclone including an opening and an exhaust port, the opening permitting discharge of the separated char vertically downward in the pressure vessel, the exhaust port permitting discharge of the produced gas to the outside of the pressure vessel; a particle storage chamber provided in a vertically lower part of the pressure vessel and storing the char discharged through the opening; and an outlet port formed in a bottom of the pressure vessel and permitting discharge of the particles stored in the particle storage chamber to the outside.

### TECHNICAL FIELD

The present invention relates to a cyclone integrated type storage device, an integrated gasification combined cycle, and a method for separating particles.

### BACKGROUND ART

A known example of gasification unit is the carbonaceous fuel gasification apparatus (coal gasification unit) that supplies a carbonaceous feedstock such as coal into a gasifier and partially combusts and gasifies the fuel to produce a combustible gas.

An integrated coal gasification combined cycle (hereinafter referred to as “IGCC”) system typically consists of a coal feeder, a coal gasifier, a char recovery unit (e.g., a cyclone and a porous filter), a gas purification unit, a gas turbine, a steam turbine, a generator, a heat recovery steam generator, and a gasification agent feeder.

In such an integrated coal gasification combined cycle system, coal (pulverized coal) is supplied from the coal feeder to the coal gasifier, and a gasification agent (e.g., air, oxygen-rich air, oxygen, and steam) is also supplied from the gasification agent feeder to the coal gasifier.

In the coal gasifier, the coal is partially oxidized and gasified by the gasification agent, producing a combustible gas (coal gas). Since the produced combustible gas contains particles (char) that are unreacted solids of the coal, the char recovery unit recovers the char and thus removes dust from the combustible gas. The combustible gas from which dust has been removed then undergoes purification by the gas purification unit, whereby impurities such as sulfur compounds and nitrogen compounds are removed. This turns the combustible gas into fuel gas, which is supplied to the gas turbine.

Patent Literatures 1 and 2 each disclose a char recovery unit including a cyclone (a centrifugal remover), a char bin (container), and a char supply hopper.

The cyclone recovers char from a combustible gas. The bin temporarily stores the char recovered by the cyclone. The char supply hopper supplies the char supplied from the bin to a char return line. The char supplied to the char return line is returned to the coal gasifier and recycled.

### CITATION LIST

### Patent Literature

### [PTL 1]

The Publication of Japanese Patent No. 5518161

### [PTL 2]

The Publication of Japanese Patent No. 5529678

### SUMMARY OF INVENTION

### Technical Problem

In the above configuration, the high-temperature and high-pressure combustible gas (produced gas) produced in the coal gasifier is sent into the cyclone. This causes a temperature difference between the cyclone and the bin, resulting in a difference in thermal elongation between the cyclone and the bin. To absorb this difference in thermal elongation, a thermal expansion absorber such as a bellows expansion member is required for a connection pipe that supplies the char from the cyclone to the bin. This leads to a complicated equipment configuration, which may increase equipment costs.

The present invention has been made in view of the above circumstances, and aims to provide a cyclone integrated type storage device, an integrated gasification combined cycle, and a method for separating particles each of which helps simplify the equipment configuration and reduces equipment costs.

### Solution to Problem

According to a first aspect of the present invention, there is provided a cyclone integrated type storage device including: a hollow pressure vessel; a cyclone provided in a vertically upper part of the pressure vessel, the cyclone being configured to swirl gas introduced from outside and containing particles to thereby separate at least some of the particles from the gas, the cyclone including an opening and an exhaust port, the opening permitting discharge of the separated particles vertically downward in the pressure vessel, the exhaust port permitting discharge of the gas to the outside of the pressure vessel; a particle storage chamber provided in a vertically lower part of the pressure vessel, the particle storage chamber storing the particles discharged through the opening; and a outlet port formed in a bottom of the pressure vessel, the outlet port permitting discharge of the particles stored in the particle storage chamber to the outside.

In this configuration, the cyclone to separate particles from the introduced gas (produced gas) is contained in the vertically upper part of the pressure vessel in which the particle storage chamber is provided. This eliminates the need for separately providing the cyclone and a container (bin) for storing the particles. This in turn eliminates the need for a pipe to connect the cyclone and the container and an expansion member, and thus simplifies the equipment configuration, helping to reduce equipment costs.

Since the cyclone is contained in the pressure vessel, the cyclone itself does not need to have a pressure resistant structure. In this respect too, equipment costs can be reduced.

In the above first aspect, the cyclone integrated type storage device preferably further includes a equalization pipe configured to communicate between an inside of the pressure vessel and an inside of a flow path of the gas discharged from the exhaust port.

In this configuration, when the particles separated by the cyclone fall down into the particle storage chamber located vertically below the cyclone, the gas present in the pressure vessel flows, by the amount equal to the volume of the fallen particles, through the equalization pipe into the flow path of the gas to be discharged through the exhaust port. This allows evening out the pressure between the inside of the pressure vessel and the inside of the flow path of the gas to be discharged through the exhaust port.

In the above first aspect, the equalization pipe preferably communicates with the inside of the pressure vessel at a position vertically above the opening.

This configuration prevents the particles separated by the cyclone from flying within the pressure vessel and rediffusing into the equalization pipe.

In the above first aspect, the particle storage chamber preferably further includes: a particle diffusion space in which a flow of the particles discharged through the opening gradually diffuses radially outward in the particle storage chamber, a lower boundary of the particle diffusion space coinciding with a position at which the diffusing particles hit an inner surface of the particle storage chamber; and a particle accumulation space formed vertically below the particle diffusion space, the particle accumulation space permitting accumulation of the particles on the bottom of the pressure vessel.

This configuration provides a space for accumulating the particles that have been discharged from the cyclone on the swirling flow and hit the inner surface of the particle storage chamber to fall downward. This prevents the particles from flying or rediffusing, and allows accumulating the particles in the particle accumulation space.

In the above first aspect, the cyclone integrated type storage device preferably further includes a feeding pipe that is connected to a filter that captures fine particles unseparated from the gas in the cyclone and discharged through the exhaust port along with the gas and that is configured to send the fine particles captured by the filter into the particle storage chamber, and the feeding pipe preferably communicates with the particle storage chamber at a position vertically below the particle diffusion space and vertically above the particle accumulation space.

In this configuration, the feeding pipe communicates with the particle storage chamber at a position vertically below the particle diffusion space. This causes fine particles sent through the feeding pipe into the particle storage chamber to be moved vertically downward by the flow of gas within the particle storage chamber, preventing the fine particles from flying vertically upward. Further, the feeding pipe communicates with the particle storage chamber at the position vertically above the particle accumulation space. Thus, the flow of fine particles sent through the feeding pipe prevents the particles accumulated in the particle accumulation space from flying upward.

In the above first aspect, a distance between a lower end of the particle diffusion space and an upper end of the particle accumulation space is preferably equal to an opening diameter of a connection port of the feeding pipe facing the particle storage chamber.

This configuration appropriately minimizes the size of the boundary between the lower end of the particle diffusion space and the upper end of the particle accumulation space. This prevents an increase in the size of the pressure vessel.

In the above first aspect, an end of the feeding pipe on a connection port side thereof facing the particle storage chamber is further preferably inclined obliquely downward at 20° or more relative to a horizontal direction.

In this configuration, the large inclination of the feeding pipe prevents the fine particles sent through the feeding pipe into the particle storage chamber from flying into the particle diffusion space and rediffusing into the equalization pipe.

According to a second aspect of the present invention, there is provided an integrated gasification combined cycle including the cyclone integrated type storage device of the above first aspect.

According to a third aspect of the present invention, there is provided a method for separating particles in the aforementioned cyclone integrated type storage device, the method including: introducing gas containing the particles from outside into the cyclone provided in the upper part of the pressure vessel, and swirling the gas to thereby separate the particles from the gas; discharging the particles separated within the cyclone downward through the opening formed at the lower end of the cyclone; storing the particles discharged downward through the opening in the particle storage chamber provided in the lower part of the pressure vessel; and discharging the particles stored in the particle storage chamber to the outside through the outlet port formed in the bottom of the pressure vessel.

### Advantageous Effects of Invention

The present invention simplifies the equipment configuration, helping to reduce equipment costs.

### BRIEF DESCRIPTION OF DRAWINGS

FIG. 1 illustrates a schematic configuration of an integrated coal gasification combined cycle system including a cyclone integrated type storage device according to an embodiment of the present invention.

FIG. 2 illustrates a configuration of a dust collector including the cyclone integrated type storage device according to the embodiment of the present invention.

FIG. 3 is a vertical cross-sectional view of the cyclone integrated type storage device according to the embodiment of the present invention.

### DESCRIPTION OF EMBODIMENTS

Embodiments of the present invention will be described below with reference to the drawings.

First of all, an explanation will be given of an integrated coal gasification combined cycle system, which is one embodiment of the integrated gasification combined cycle of the present invention.

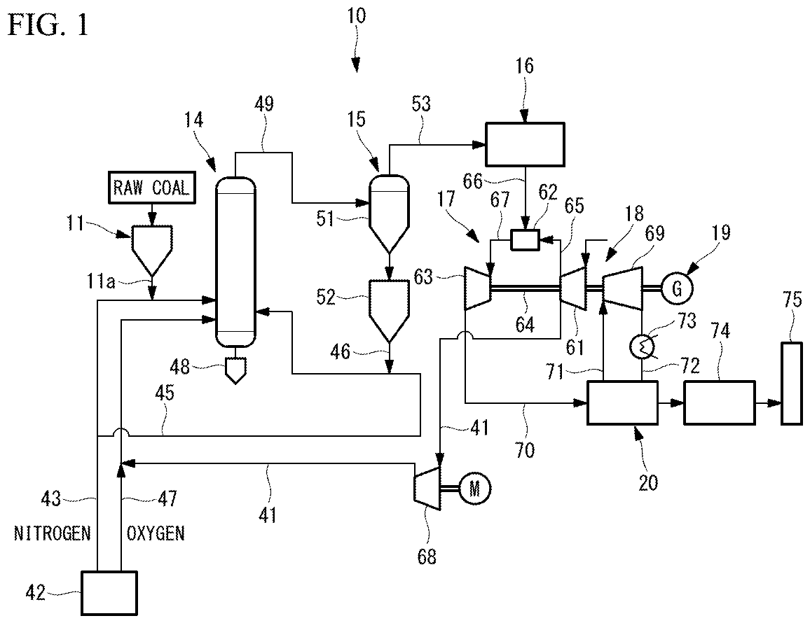

As shown in FIG. 1, the integrated coal gasification combined cycle (IGCC) system 10 employs an air combustion method whereby the integrated coal gasification combined cycle system 10 uses air as a main oxidation agent and produces a combustible gas (produced gas) from fuel in a gasification unit 14. The integrated coal gasification combined cycle system (the integrated gasification combined cycle) 10 then purifies the produced gas produced in the gasification unit 14 into fuel gas in a gas purification unit 16, and supplies the fuel gas to a gas turbine 17 for power generation. In other words, the integrated coal gasification combined cycle system 10 of the present embodiment is an air combustion type (air-blown) power generating system. Examples of the fuel supplied to the gasification unit 14 include carbonaceous feedstocks such as coal.

The integrated coal gasification combined cycle system 10 includes a coal feeder 11, the gasification unit 14, a char recovery unit 15, the gas purification unit 16, the gas turbine 17, a steam turbine 18, a generator 19, and a heat recovery steam generator (HRSG) 20.

The coal feeder 11 is supplied with raw coal, which is a carbonaceous feedstock, and pulverizes the coal by a coal mill and the like (not shown in the figure) to produce pulverized coal consisting of fine particles. The pulverized coal produced by the coal feeder 11 is pressurized at an outlet of a coal feeding line 11a by nitrogen gas supplied from an air separation unit 42 (described later) as conveyance inert gas, and is then supplied to the gasification unit 14. The inert gas is a gas that contains about 5 or less volume percent of oxygen, and representative examples include nitrogen gas, carbon dioxide gas and argon gas. However, the volume percent of oxygen is not necessarily limited to 5 or less.

The gasification unit 14 is supplied with the pulverized coal produced by the coal feeder 11, and also supplied with char (unreacted coal and ash) recovered by the char recovery unit 15 and returned to the gasification unit 14 for their reuse.

Connected to the gasification unit 14 is a compressed air supply line 41 extending from the gas turbine 17 (a compressor 61). This allows a part of compressed air compressed by the gas turbine 17 to be boosted to a predetermined pressure by a booster 68 before being supplied to the gasification unit 14. The air separation unit 42 separates nitrogen and oxygen from the atmospheric air. The air separation unit 42 and the gasification unit 14 are connected with a first nitrogen supply line 43. Connected to the first nitrogen supply line 43 is the coal feeding line 11a extending from the coal feeder 11. Also connected to the gasification unit 14 is a second nitrogen supply line 45 branching off from the first nitrogen supply line 43. Connected to the second nitrogen supply line 45 is a char return line 46 extending from the char recovery unit 15. The air separation unit 42 and the compressed air supply line 41 are connected with an oxygen supply line 47. Nitrogen separated by the air separation unit 42 circulates through the first nitrogen supply line 43 and the second nitrogen supply line 45 to be used as a conveyance gas for coal and char. Oxygen separated by the air separation unit 42 circulates through the oxygen supply line 47 and the compressed air supply line 41 to be used as an oxidation agent in the gasification unit 14.

The gasification unit 14 includes, for example, a two-stage entrained bed gasifier. The gasification unit 14 partially combusts the internally supplied coal (pulverized coal) and char by the oxidation agent (air and oxygen) to gasify them into a produced gas (gas). The gasification unit 14 is provided with a foreign object remover 48 that removes foreign objects (slag) mixed into the pulverized coal. Connected to the gasification unit 14 is a gas generation line 49 to supply the produced gas to the char recovery unit 15. This allows the gasification unit 14 to discharge the produced gas containing the char. The gas generation line 49 may be provided with a syngas cooler (gas cooler) to cool the produced gas to a predetermined temperature before supplying it to the char recovery unit 15.

The char recovery unit 15 includes a dust collector 51 and a char supply hopper 52. The dust collector 51 separates the char contained in the produced gas produced by the gasification unit 14. The produced gas from which the char has been separated is sent through a gas discharge line 53 to the gas purification unit 16. The char supply hopper 52 stores the char separated from the produced gas by the dust collector 51. The char return line 46 extending from the char supply hopper 52 is connected to the second nitrogen supply line 45.

The gas purification unit 16 removes impurities, such as sulfur compounds and nitrogen compounds, from the produced gas from which the char has been separated by the char recovery unit 15, and thereby purifies the gas. The gas purification unit 16 purifies the produced gas into fuel gas and supplies the fuel gas to the gas turbine 17. Since the produced gas from which the char has been separated still contains sulfur components (e.g., H₂S), the gas purification unit 16 removes and recovers the sulfur components by amine absorption liquid and the like for their effective use.

The gas turbine 17 includes the compressor 61, a combustor 62, and a turbine 63. The compressor 61 and the turbine 63 are coupled with a rotary shaft 64. Connected to the combustor 62 is a compressed air supply line 65 extending from the compressor 61, a fuel gas supply line 66 extending from the gas purification unit 16, and a combustion gas supply line 67 extending to the turbine 63. The gas turbine 17 is provided with the compressed air supply line 41 extending from the compressor 61 to the gasification unit 14, and the booster 68 is provided in the middle of the compressed air supply line 41. Thus, the combustor 62 mixes a part of the compressed air supplied from the compressor 61 and at least a part of the fuel gas supplied from the gas purification unit 16 and combusts them to generate a combustion gas, and supplies the generated combustion gas to the turbine 63. The turbine 63 rotates the rotary shaft 64 by the supplied combustion gas and thereby drives the generator 19.

A steam turbine 18 includes a turbine 69 coupled to the rotary shaft 64 of the gas turbine 17. The generator 19 is coupled to a base end of the rotary shaft 64. The heat recovery steam generator 20 is connected to a flue gas line 70 extending from the gas turbine 17 (the turbine 63), and exchanges heat between the water supplied to the heat recovery steam generator 20 and the flue gas discharged from the turbine 63 to thereby generate steam. The heat recovery steam generator 20 is provided with a steam supply line 71 connected to the turbine 69 of the steam turbine 18 and also provided with a steam recovery line 72, which is provided with a condenser 73. The steam generated by the heat recovery steam generator 20 may include steam generated through heat exchange with the produced gas in the syngas cooler of the gasification unit 14. Thus, in the steam turbine 18, the turbine 69 is rotated by the steam supplied from the heat recovery steam generator 20 so as to rotate the rotary shaft 64, whereby the generator 19 is driven.

A gas cleaning unit 74 is provided between an outlet of the heat recovery steam generator 20 and a stack 75.

An explanation will be given of operations of the integrated coal gasification combined cycle 10 of the present embodiment.

In the integrated coal gasification combined cycle 10 of the present embodiment, the coal feeder 11 pulverizes supplied raw coal (coal) by its coal mill (not shown in the figure) into pulverized coal consisting of fine particles. The pulverized coal produced by the coal feeder 11 is made flow through the first nitrogen supply line 43 by nitrogen supplied from the air separation unit 42, and thus supplied to the gasification unit 14. The char recovered by the char recovery unit 15 (described later) is made flow through the second nitrogen supply line 45 by nitrogen supplied from the air separation unit 42, and thus supplied to the gasification unit 14. The compressed air extracted from the gas turbine 17 (described later) is boosted by the booster 68 before being supplied to the gasification unit 14 via the compressed air supply line 41 together with oxygen supplied from the air separation unit 42.

The gasification unit 14 combusts the supplied pulverized coal and char by the compressed air (oxygen) to gasify the pulverized coal and char, thus producing the produced gas. The produced gas is discharged from the gasification unit 14 through the gas generation line 49 to the char recovery unit 15.

In the char recovery unit 15, the produced gas is first supplied to the dust collector 51, where fine char contained in the produced gas is separated from the produced gas. The produced gas from which the char has been removed is sent through the gas discharge line 53 to the gas purification unit 16. Meanwhile, the fine char separated from the produced gas is accumulated on the char supply hopper 52, and returned through the char return line 46 to the gasification unit 14 to be recycled.

The produced gas from which the char has been separated by the char recovery unit 15 undergoes gas purification by the gas purification unit 16, whereby impurities such as sulfur compounds and nitrogen compounds are removed from the produced gas. This produces the fuel gas. The compressor 61 produces the compressed air and supplies it to the combustor 62. The combustor 62 mixes the compressed air supplied from the compressor 61 and the fuel gas supplied from the gas purification unit 16 and combusts them to produce the combustion gas. The turbine 63 is rotated by this combustion gas, which in turn drives the compressor 61 and the generator 19 via the rotary shaft 64. Thus, the gas turbine 17 can generate power.

The heat recovery steam generator 20 exchanges heat between the flue gas discharged from the turbine 63 of the gas turbine 17 and the water supplied to the heat recovery steam generator 20 to produce steam, and supplies the produced steam to the steam turbine 18. In the steam turbine 18, the turbine 69 is rotated by the steam supplied from the heat recovery steam generator 20, which in turn drives the generator 19 via the rotary shaft 64, generating power.

It is not essential that the gas turbine 17 and the steam turbine 18 are coaxially arranged to drive one generator 19; the gas turbine 17 and the steam turbine 18 may be on different axes to drive multiple generators.

Thereafter, toxic substances in the flue gas discharged from the heat recovery steam generator 20 are removed in the gas cleaning unit 74, and the cleaned flue gas is discharged through the stack 75 to the atmosphere.

A detailed explanation will be given of the dust collector 51 provided to the aforementioned char recovery unit 15.

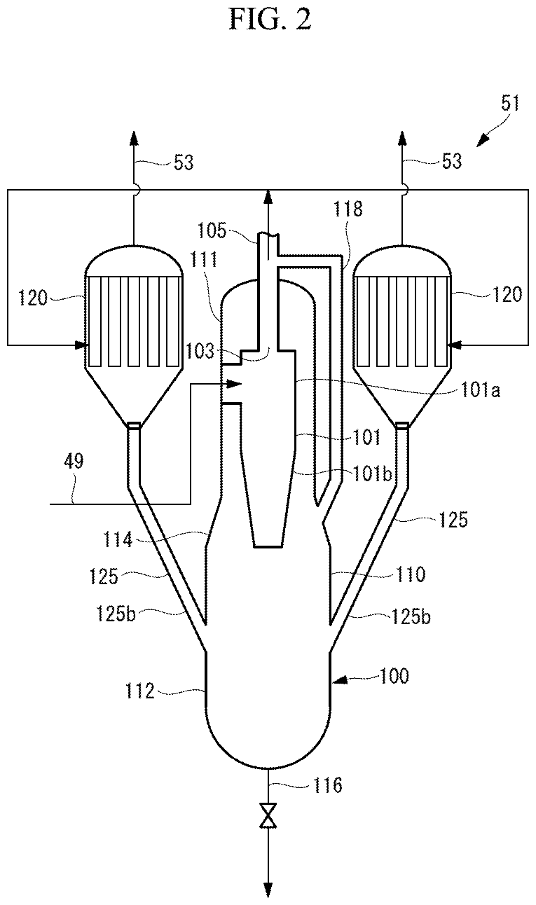

As shown in FIG. 2, the dust collector 51 includes a cyclone integrated type storage device 100 as a primary dust collector, and a porous filter (filter) 120 as a secondary dust collector.

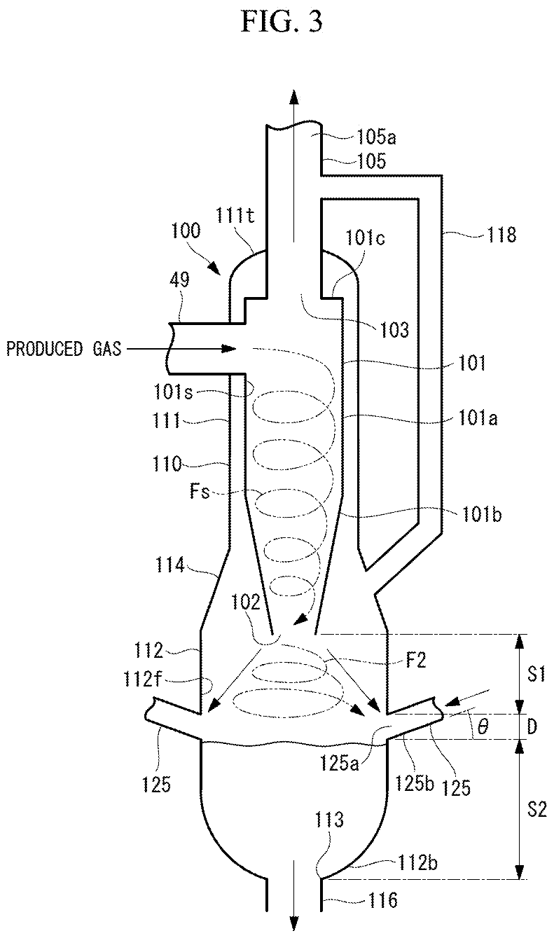

As shown in FIGS. 2 and 3, the cyclone integrated type storage device 100 includes a pressure vessel 110 and a cyclone 101.

The pressure vessel 110 is hollow and resistant against pressure of the high-temperature and high-pressure produced gas sent from the gasification unit 14 through the gas generation line 49. The pressure vessel 110 includes a cyclone chamber 111 formed in an upper part of the pressure vessel 110, and a particle storage chamber 112 formed in a lower part of the pressure vessel 110.

The cyclone chamber 111 has a cylindrical shape continuous in a vertical direction, and contains the cyclone 101 inside thereof. The cyclone chamber 111 includes a top lilt having, for example, a dome shape whose inner diameter gradually decreases vertically upward.

The particle storage chamber 112 has a cylindrical shape whose inner diameter is larger than that of the cyclone chamber 111. Thus, the particle storage chamber 112 has a larger horizontal cross-sectional area than that of the cyclone chamber 111, ensuring a storage capacity for the char (particles) while reducing the vertical size of the particle storage chamber 112. This in turns prevents the pressure vessel 110 from increasing its vertical size.

The particle storage chamber 112 is formed below a lower end of the cyclone chamber 111. The particle storage chamber 112 is continuous from the cyclone chamber 111 via a widened part 114 whose inner diameter gradually increases downward.

The particle storage chamber 112 includes a bottom 112b having, for example, a mortar shape whose inner diameter gradually decreases downward. An inner surface of the bottom 112b of the particle storage chamber 112 is inclined at an angle equal to or larger than an angle of repose of the char accumulated in the particle storage chamber 112. This facilitates discharge of the char accumulated in the particle storage chamber 112 toward a outlet port 113.

The outlet port 113 that opens downward is formed in the bottom 112b of the particle storage chamber 112. Connected to the outlet port 113 is a char supply pipe 116 that communicates with the char supply hopper 52. Opening and closing a valve (not shown in the figure) provided on the way of the char supply pipe 116 enables to discharge the char.

The cyclone 101 contained in the cyclone chamber 111 includes a cylindrical part 101a continuous in the vertical direction and a tapered part 101b whose inner diameter gradually decreases downward from a lower end of the cylindrical part 101a. The cylindrical part 101a and the tapered part 101b are integrated in a single body. An upper end of the cylindrical part 101a is closed by a disc-like plate 101c so as to connect to an exhaust pipe 105. A lower end of the tapered part 101b is provided with an opening 102 through which the char is discharged downward in the pressure vessel 110.

The plate 101c at the upper end of the cyclone 101 is provided with an exhaust port 103. Connected to the exhaust port 103 is the exhaust pipe 105 running vertically upward through the top lilt of the cyclone chamber 111 of the pressure vessel 110. This forms a flow path through which the produced gas from which the char has been removed by the cyclone 101 (described later) is discharged.

Connected to a surrounding wall 101s of the cylindrical part 101a of the cyclone 101 is the gas generation line 49 through which the produced gas is sent from the gasification unit 14. The gas generation line 49 is connected to the surrounding wall 101s of the cyclone 101 in a tangential direction in plan view. This causes the produced gas sent through the gas generation line 49 to swirl in a circumferential direction within the cyclone 101.

When the produced gas is sent from the gasification unit 14 through the gas generation line 49 to this cyclone 101, at least some of the char (in the present embodiment, most of the char) contained in the produced gas, in particular those of coarse particles, are thrown outward within the cyclone 101 by the centrifugal force of a swirling flow Fs generated inside the cyclone 101. While swirling on the swirling flow Fs, the outwardly thrown char falls down in the gravitational direction by their own weight. Eventually, the char is discharged downward from the cyclone 101 through the opening 102. In this way, the cyclone 101 centrifugally separates at least some of the char from the produced gas. The produced gas, from which most of the char has been separated with some fine particles left unseparated, is discharged through the exhaust port 103 into the exhaust pipe 105 located above, and sent to the porous filter 120 as the secondary dust collector.

The char discharged through the opening 102 of the cyclone 101 falls down into the particle storage chamber 112 by their own weight. At this time, a part of a flow F2 of the char discharged through the opening 102 together with the residual produced gas gradually increases its turning radius by the centrifugal force as it goes downward while swirling by the inertial force of the swirling flow Fs inside the cyclone 101. Eventually, a part of this flow F2 falls down in the particle storage chamber 112 by gravity, and another part of the flow F2 hits an inner surface 112f of the particle storage chamber 112. The char falls downward in the gravitational direction and accumulate on the bottom 112b of the particle storage chamber 112 of the pressure vessel 110.

Thus, a particle diffusion space S1 is defined in an upper part of the particle storage chamber 112 where the flow F2 of the char discharged through the opening 102 falls down while gradually diffusing radially outward and a part of the flow F2 hits the inner surface of the particle storage chamber 112. Defined below the particle diffusion space S1 in the particle storage chamber 112 is a particle accumulation space S2 where the char accumulates on the bottom of the pressure vessel 110.

In other words, the particle diffusion space S1 is a space that allows the flow F2 of the char discharged through the opening 102 to diffuse gradually radially outward and that is vertically above the lowest position at which the particles hit the inner surface of the particle storage chamber 112. The particle accumulation space S2 is a space that is vertically below the lowest position at which the particles of the flow F2 of the char discharged through the opening 102 hit the inner surface of the particle storage chamber 112 and also vertically below a connection port 125a.

The char accumulated in the particle accumulation space S2 of the particle storage chamber 112 of the pressure vessel 110 is supplied from the outlet port 113 through the char supply pipe 116 to the char supply hopper 52 located vertically below. The char supply hopper 52 temporarily stores the char supplied from the cyclone integrated type storage device 100, and supplies the char through the char return line 46 to the gasification unit 14.

Multiple char supply hoppers 52 may be connected to one cyclone integrated type storage device 100. In this case, multiple outlet ports 113 are formed in the bottom of the pressure vessel 110, and char supply pipes 116 are connected to the respective discharge ports 113.

The cyclone integrated type storage device 100 further includes a equalization pipe 118 that communicates with the inside of the pressure vessel 110 and the inside of the flow path 105a of the produced gas in the exhaust pipe 105 connected to the exhaust port 103 of the cyclone 101. When the char separated from the produced gas by the cyclone 101 falls down into the particle storage chamber 112, the produced gas present in the particle storage chamber 112 is pushed out into the equalization pipe 118 by the amount equal to the volume of the fallen char. The produced gas having flowed into the equalization pipe 118 is sent into the flow path 105a of the exhaust pipe 105. This prevents an increase in pressure inside the particle storage chamber 112, evening out the pressure between the inside of the particle storage chamber 112 and the inside of the exhaust pipe 105.

The equalization pipe 118 communicates with the pressure vessel 110 at a position vertically above the opening 102 at the lower end of the cyclone 101. This prevents the fallen char separated by the cyclone 101 from flying and directly flowing into the equalization pipe 118 together with the produced gas pushed out from the particle storage chamber 112 and rediffusing into the flow path 105a downstream of the cyclone 101.

As shown in FIG. 2, the produced gas discharged from the exhaust port 103 of the cyclone 101 is sent to the porous filter 120 through the exhaust pipe 105. The porous filter 120 captures the char (fine particles) unseparated by the cyclone 101 and remaining in the produced gas.

The produced gas from which the char (fine particles) has been separated by the porous filter 120 is sent through the gas discharge line 53 to the gas purification unit 16.

Meanwhile, the fine particles captured by the porous filter 120 are sent through a feeding pipe 125 to the particle storage chamber 112 of the cyclone integrated type storage device 100.

As shown in FIG. 3, in the cyclone integrated type storage device 100, the feeding pipe 125 is connected to the particle storage chamber 112 at a position below the particle diffusion space S1 and above the particle accumulation space S2.

The distance between the lower end of the particle diffusion space S1 and the upper end of the particle accumulation space S2 is equal to an opening diameter D of the connection port 125a of the feeding pipe 125 facing the particle storage chamber 112. In other words, the connection port 125a of the feeding pipe 125 is located at a boundary between the lower end of the particle diffusion space S1 and the upper end of the particle accumulation space S2

Further, it is preferable that an end 125b of the feeding pipe 125 at least on the connection port 125a side thereof be connected to the pressure vessel 110 at an inclination angle θ of 20° or more relative to a horizontal direction. This causes the char (fine particles) supplied through the feeding pipe 125 to fall down below the lower end of the particle diffusion space S1 of the particle storage chamber 112. This prevents the char from flying or rediffusing, allowing accumulation of the char in the particle accumulation space S2.

It is preferable that assist gas be sent into the feeding pipe 125 from the lower side of the feeding pipe 125 to facilitate flow of the char within the feeding pipe 125.

Then, an explanation will be given of a method to separate the char from the produced gas by the cyclone integrated type storage device 100 that is vertically disposed as described above.

In separating the char from the produced gas by the cyclone integrated type storage device 100, the produced gas containing the char is first introduced from the outside (from the gas generation line 49) into the cyclone 101 provided in the upper area of the pressure vessel 110. The produced gas is swirled in the cyclone 101, which results in at least some of the char being separated from the produced gas. The char separated within the cyclone 101 is discharged downward through the opening 102 formed at the lower end of the cyclone 101. The char discharged downward through the opening 102 is stored in the particle storage chamber 112 provided in the lower part of the pressure vessel 110. The char stored in the particle storage chamber 112 is discharged outside through the outlet port 113 formed in the bottom of the pressure vessel 110.

The above-described cyclone integrated type storage device 100 includes the cyclone 101 for separating char from gas in the upper part of the pressure vessel 110 in which the particle storage chamber 112 is provided. This eliminates the need for separately providing the cyclone 101 and a container (bin) for storing the char. This in turn eliminates the need for a pipe to connect the cyclone 101 and the container (bin) and an expansion member required for the pipe connection, and thus simplifies the equipment configuration, helping to reduce equipment costs.

Since the cyclone 101 is contained in the pressure vessel 110, the cyclone 101 itself does not need to have a shape, wall thickness or seal structure that ensures its pressure resistance. In this respect too, equipment costs can be reduced.

Further, the cyclone integrated type storage device 100 includes the equalization pipe 118. Thus, when the char separated by the cyclone 101 falls down into the particle storage chamber 112 located vertically below the cyclone 101, the produced gas present in the particle storage chamber 112 is pushed out into the equalization pipe 118 by the amount equal to the volume of the fallen char. The produced gas having flowed into the equalization pipe 118 can be sent into the flow path 105a of the exhaust pipe 105. This allows evening out the pressure between the inside of the pressure vessel 110 and the inside of the flow path 105a of the gas discharged from the exhaust port 103.

The equalization pipe 118 communicates with the pressure vessel 110 at the position vertically above the opening 102 of the cyclone 101. This prevents the fallen char separated by the cyclone 101 from flying or rediffusing into the equalization pipe 118.

Further, the feeding pipe 125 for sending the char captured by the porous filter 120 to the particle storage chamber 112 is connected to the particle storage chamber 112 at the position vertically below the particle diffusion space S1 and vertically above the particle accumulation space S2. Connecting the feeding pipe 125 at the position below the particle diffusion space S1 in this way allows the char discharged from the feeding pipe 125 to move downward along with the flow F2 of the gas in the particle diffusion space S1. This prevents the char from flying or rediffusing upward. The flow of fine particles transported through the feeding pipe 125 and the flow F2 from the opening 102 also prevent the char accumulated in the particle accumulation space S2 from flying or rediffusing upward.

The distance between the lower end of the particle diffusion space S1 and the upper end of the particle accumulation space S2 is made equal to the opening diameter D of the connection port 125a of the feeding pipe 125 facing the particle storage chamber 112. This appropriately minimizes the size of the boundary between the lower end of the particle diffusion space S1 and the upper end of the particle accumulation space S2. This prevents the cyclone integrated type storage device 100 from increasing its vertical size.

At least one end 125b of the feeding pipe 125 on the connection port 125a side thereof, which is relative to an end facing a vertically lower part of the porous filter 120, is inclined obliquely downward at an angle of 20° or more relative to the horizontal direction. This large inclination of the feeding pipe 125 allows stable transportation of the char (fine particles) through the feeding pipe 125, which results in the supplied char (fine particles) falling down into the particle accumulation space S2 in the lower part of the particle storage chamber 112. This prevents the char from flying or rediffusing into the particle diffusion space S1 and flowing into the equalization pipe 118, and allows accumulation of the char in the particle accumulation space S2. When at least one end 125b of the feeding pipe 125 on the connection port 125a side thereof is inclined at a smaller angle, which is at least 20°, relative to the horizontal direction, the porous filter 120 can be placed closer to the pressure vessel 110. On the other hand, when at least one end 125b of the feeding pipe 125 on the connection port 125a side thereof is inclined at an angle larger than 20° relative to the horizontal direction, the porous filter 120 can be placed vertically above the pressure vessel 110 of the cyclone integrated type storage device 100, and this prevents interference between the porous filter 120 and the pressure vessel 110. Thus, the inclination angle of at least one end 125b of the feeding pipe 125 on the connection port 125a side thereof may be optionally selected from angles of 20° or more relative to the horizontal direction. This improves flexibility in the layout of the cyclone integrated type storage device 100 and the porous filter 120, helping to downsize the char recovery unit 15.

Although the above embodiment has described, by way of example, the IGCC system including a coal gasifier that produces a combustible gas from pulverized coal, the gasification unit of the present invention is applicable to gasification of other carbonaceous feedstocks such as biomass fuels, which include timber from forest thinning, waste wood, driftwood, grasses, waste, sludge, and tire. Further, use of the gasification unit of the present invention is not limited to power generation; the gasification unit can be used in a chemical plant gasifier to obtain desired chemical substances.

In the above embodiment, coal is used as a fuel, and the coal may be either high-grade or low-grade. Further, the fuel is not limited to the coal, and may be a biomass fuel that is used as recyclable, biological organic resources. Examples of the biomass fuel include timber from forest thinning, waste wood, driftwood, grasses, waste, sludge, tire, and recycled fuels (e.g., pellets and chips) made from these resources.

### REFERENCE SIGNS LIST

10 Integrated coal gasification combined cycle (integrated gasification combined cycle)
11 Coal feeder
11a Coal feeding line
14 Gasification unit
15 Char recovery unit
16 Gas purification unit
17 Gas turbine
18 Steam turbine
19 Generator
20 Heat recovery steam generator
41 Compressed air supply line
42 Air separation unit
43 First nitrogen supply line
45 Second nitrogen supply line
46 Char return line
47 Oxygen supply line
48 Foreign object remover
49 Gas generation line
51 Dust collector
52 Char supply hopper
53 Gas discharge line
61 Compressor
62 Combustor
63 Turbine
64 Rotary shaft
65 Compressed air supply line
66 Fuel gas supply line
67 Combustion gas supply line
68 Booster
69 Turbine
70 Flue gas line
71 Steam supply line
72 Steam recovery line
73 Condenser
74 Gas cleaning unit
75 Stack
100 Cyclone integrated type storage device
101 Cyclone
101a Cylindrical part
101b Tapered part
101c Plate
101s Surrounding wall
102 Opening
103 Exhaust port
105 Exhaust pipe
105a Flow path
110 Pressure vessel
111 Cyclone chamber
111t Top
112 Particle storage chamber
112b Bottom
112f Inner surface
113 Outlet port
114 Widened part
116 Char supply pipe
118 Equalization pipe
120 Porous filter (filter)
125 Feeding pipe
125a Connection port
125b End
S1 Particle diffusion space
S2 Particle accumulation space
θ Inclination angle

1-9. (canceled)

10. A cyclone integrated type storage device comprising:
a hollow pressure vessel;
a cylindrical cyclone chamber formed in a vertically upper part of the pressure vessel;
a cyclone provided within the cyclone chamber, the cyclone being configured to swirl gas introduced from outside and containing particles to thereby separate at least some of the particles from the gas, the cyclone including an opening and an exhaust port, the opening permitting discharge of the separated particles vertically downward in the pressure vessel, the exhaust port permitting discharge of the gas to the outside of the pressure vessel;
a cylindrical particle storage chamber formed in a vertically lower part of the pressure vessel, the particle storage chamber storing the particles discharged through the opening, the particle storage chamber having a lager inner diameter than an inner diameter of the cyclone chamber; and
an outlet port formed in a bottom of the pressure vessel, the outlet port permitting discharge of the particles stored in the particle storage chamber to the outside.

11. The cyclone integrated type storage device according to claim 10, further comprising an equalization pipe configured to communicate between an inside of the pressure vessel and an inside of a flow path of the gas discharged from the exhaust port.

12. The cyclone integrated type storage device according to claim 11, wherein the equalization pipe communicates with the inside of the pressure vessel at a position vertically above the opening.

13. The cyclone integrated type storage device according to claim 10, wherein the particle storage chamber comprises:
a particle diffusion space in which a flow of the particles discharged through the opening gradually diffuses radially outward in the particle storage chamber, a lower boundary of the particle diffusion space coinciding with a position at which the diffusing particles hit an inner surface of the particle storage chamber; and
a particle accumulation space formed vertically below the particle diffusion space, the particle accumulation space permitting accumulation of the particles on the bottom of the pressure vessel.

14. The cyclone integrated type storage device according to claim 13, further comprising a feeding pipe that is connected to a filter that captures fine particles unseparated from the gas in the cyclone and discharged through the exhaust port along with the gas and that is configured to send the fine particles captured by the filter into the particle storage chamber,
wherein the feeding pipe communicates with the particle storage chamber at a position vertically below the particle diffusion space and vertically above the particle accumulation space.

15. The cyclone integrated type storage device according to claim 14, wherein a distance between a lower end of the particle diffusion space and an upper end of the particle accumulation space is equal to an opening diameter of a connection port of the feeding pipe facing the particle storage chamber.

16. The cyclone integrated type storage device according to claim 14, wherein an end of the feeding pipe on a connection port side thereof facing the particle storage chamber is inclined obliquely downward at 20° or more relative to a horizontal direction.

17. A gasification combined power generating device comprising the cyclone integrated type storage device according claim 10.

18. A method for separating particles in the cyclone integrated type storage device according to claim 10, the method comprising:
introducing gas containing the particles from outside into the cyclone provided in the vertically upper part of the pressure vessel, and swirling the gas to thereby separate at least some of the particles from the gas;
discharging the particles separated in the cyclone vertically downward through the opening formed at a lower end of the cyclone;
storing the particles discharged downward through the opening in the particle storage chamber provided in the vertically lower part of the pressure vessel; and
discharging the particles stored in the particle storage chamber to the outside through the outlet port formed in the bottom of the pressure vessel.

19. The cyclone integrated type storage device according to claim 14, wherein the filter is provided at a position lateral to the cyclone chamber and above the particle storage chamber.
